(19) United States
(12) Patent Application Publication
(10) Pub. No.: US 2016/0343064 A1
(43) Pub. Date: Nov. 24, 2016

(54) ONLINE MERCHANDIZING SYSTEMS AND METHODS THAT USE 360 PRODUCT VIEW PHOTOGRAPHY WITH USER-INITIATED PRODUCT FEATURE MOVEMENT

(71) Applicant: Jon CHRISTOPHER, Carlsbad, CA (US)

(72) Inventor: Jon CHRISTOPHER, Carlsbad, CA (US)

(21) Appl. No.: 14/718,001

(22) Filed: May 20, 2015

(51) Int. Cl. G06Q 30/06; G06F 3/0481; G06F 3/0484; G06T 13/20; G06F 3/0488

(52) U.S. Cl. CPC G06Q 30/0643; G06T 13/20; G06F 3/0488; G06F 3/04845; G06F 3/04815

(57) ABSTRACT

The present invention concerns e-commerce systems and methods that provide a prospective purchaser of a particular product the ability to operate and interact with images of the product displayed on a screen to demonstrate how the product appears when one or more of the product's operable features changes position (e.g., is opened or closed). Such interactivity is provided through a series of images that captured using stop motion photography, particularly 360 product view photography

### RELATED APPLICATION(S)

Not applicable.

### FIELD OF THE INVENTION

The invention generally relates to the processing and display of data. Specifically, the invention concerns networked computers, systems, and methods of displaying user-manipulable images of products to prospective buyers.

### BACKGROUND OF THE INVENTION

Retailers of products and services frequently use advertising to promote the sales of goods and services. In promoting a particular good, for example, a seller may use a network-based e-commerce system to present information referencing the product to a system user (e.g., a potential buyer). Examples of network-based e-commerce systems include shopping websites, classified advertisement websites, auction websites, and payment websites. Examples of information referencing the product include product information documents, product reviews, comments concerning the product, view product pages, search results, advertisements, recommendations, suggestions, auction listings, wish lists, or any desired combination of such information.

Current approaches for the display and merchandizing of products online fall far short of an in-store experience. For example, it is often hard to tell what material(s) an object is(are) made from, the quality of construction, the product's overall product dimensions, and, if the product has moveable or operable features, how those features operate and how the product appears during and after such operation. With most conventional online merchandizing, there are generally 1-6 photos that represent the product overall, hardly better than what is available in current hard copy product catalogs, and the quality of those static photos falls far short of what a prospective buyer would see if viewing the particular product in person.

More recently, a few online retailers have begun to deploy product imagery using 360 product view technology, but again, the quality of the photos used to represent the product generally still fall far short of an “in person” experience. Moreover, such technology typically does not work well on mobile devices such as smartphones and tablet computers, where it is estimated that over 50% of online purchases originate. In fact, the product viewing experience is often so terrible that most successful online retailers must offer free shipping and generous product return policies through their websites in order to turn browsers into buyers. And perhaps even more importantly, the ability collapse products, open pockets, and experience items in a tactile and moveable fashion is not currently available.

This invention addresses the aforementioned problems and shortcomings of existing online merchandizing processes and systems.

### SUMMARY OF THE INVENTION

The object of the invention is to enhance online merchandizing capabilities by providing prospective purchasers the ability to operate and interact with images of a product of interest displayed on the prospect's computer display or touchscreen screen to demonstrate how the product appears when one or more of the product's operable features changes position.

Thus, one aspect of the invention provides systems for displaying a stop motion, image-based animation of a product of interest on a remote computing device display, optionally a display of a remote desktop or laptop computer, a tablet computer, or a smartphone in electronic communication with the system. Such systems include a remote, internet-connected storage device that stores a digital image library that comprises a plurality of digital images of the product of interest taken from different angles, at least two of which show an operable feature of the product of interest in a different position. These systems also include software or firmware that allows an Internet-connectable user device, e.g., a desktop or laptop computer, a tablet computer, or a smartphone, in electronic communication with the system to (i) access, retrieve, and display on the device's display a plurality of images from the digital image library of the product of interest, and (ii) access, retrieve, and display on the device's display a stop motion, image-based animation of the product of interest in a manner that allows the user to interact with the animation via the touchscreen to observe functionality of the operable feature of the product of interest.

Another aspect of the invention concerns methods that include (i) accessing via an e-commerce website a digital image library representing a product of interest having at least one operable feature, wherein the digital image library comprises a plurality of digital images of the product of interest taken from different angles, at least two of which show an operable feature of the product of interest in a different position; and (ii) directing the display of a stop motion, image-based animation comprised of a plurality of images of the product of interest to a prospective buyer's remote computing device display, optionally a display of a remote desktop or laptop computer, a tablet computer, or a smartphone, in electronic communication with e-commerce website, wherein the display allows the prospective buyer to interact with the animation via the remote computing device display, optionally a touchscreen, to observe functionality of the operable feature of the product of interest.

### BRIEF DESCRIPTION OF THE DRAWINGS

FIG. 1 illustrates a view of a 360 product view studio of the invention.

FIG. 2 illustrates a view of the 360 product view studio of FIG. 1 but including an acrylic disk or turntable.

FIG. 3 illustrates a view of the 360 product view studio of FIGS. 1 and 2 having a back pack suspended from a monofilament line.

FIG. 4 illustrates a view of the 360 product view studio of FIGS. 1 and 2 having a high-heeled woman's show positioned on the turntable.

FIG. 5 shows an example of image “tiling”.

### DETAILED DESCRIPTION OF THE INVENTION

### Overview

The present invention concerns e-commerce systems and methods that provide a prospective purchaser of a particular product the ability to operate and interact with images of the product displayed on a screen to demonstrate how the product appears when one or more of the product's operable features changes position (e.g., is opened or closed). Such interactivity is provided through a series of images that captured using stop motion photography, particularly 360 product view photography. When viewed by prospective buyer on his/her device (e.g., a desktop, laptop, or tablet computer, a smartphone, etc.), the user can manipulate one or more features of the displayed product by moving, for example, her/his finger on the touch screen of a mobile device (e.g., a tablet computer, a smartphone, etc.) or a computer mouse in order to move a particular moveable or operable feature of the product. The invention works through all modern web browsers and mobile applications and thus can be embedded into third party web pages that can be viewed on any stationary or mobile computing device anywhere in the world, provided the device has an internet browser and internet connection.

Representative e-commerce systems of the invention direct the display of user-manipulable product views to a system user, e.g., a prospective purchaser of the product views of which are displayed to the user.

In this specification, any of the representative examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of exemplary, non-limiting, representative embodiments. It will be evident to those skilled in the art, however, that the present invention can be practiced without these specific details.

In order to generate user-manipulable product views of a product of interest to a user, 360 product view photography is preferably utilized, often through the use of a flash viewer. 360 product viewing can be used for any type of product sold online, including clothes, jewelry, gifts, consumer electronics, computer hardware, toys, housewares, sports equipment, tools, health and beauty products, etc. Non-commercial applications are also envisioned, for example, for education, news dissemination, charity, etc.

360 product view photography is also sometimes referred to as “rotary view”, “360 view”, or “3D view”.

360 product viewing is a marketing and sales tool that adds another dimension to product merchandizing. Indeed, 360 product viewing is considered a very effective method to promote products in online stores and other e-commerce venues. It allows visitors and potential customers to rotate products, examine them in detail (e.g., by zooming in), and thus make better informed decisions. In this invention, the system that provides for 360 product viewing also provides the user with the ability to manipulate one or more product features (e.g., to open and close a pocket, move a zipper, collapse or unfold a collapsible stroller, etc.).

The value of 360 product viewing to retailers is now being better appreciated. For example, a prospective customer's online shopping experience can be vastly improved when is available in an e-commerce shop. Even more importantly, the prospective customer's likelihood to purchase can be increased by 25%-50% or more. 360 product viewing can also significantly reduce product returns because a such viewing provides better feature communication to customers prior to purchase decisions being made.

To make 360 product viewing of a particular desired or target product possible, 360 product view photography is used. The process typically involves taking a plurality of digital photographs of the product, preferably positioned on a white background, as it (or the camera) is rotated through 360 degrees (one complete revolution). In preferred embodiments, the product to be imaged is rotated in front of the digital camera. As will be appreciated, increasing the number of photos improves the smoothness of the rotation. For commercial purposes, 10-60 photos, or frames, per revolution are utilized, although in the present invention larger numbers of frames are envisioned, for example, 120, 240, 360, 720, and 1440, frames, although the upper limit of frames is in actuality only constrained by the technology available to photograph, transmit, and display images to a user. The succession of images, when displayed, give the impression of rotatable 360° viewing.

In many embodiments, the image data from the camera is stored on the camera's memory card. After or while the photographs are being taken, the digital image files (e.g., JPG/RAW) are then transferred from the camera to a digital file storage system on a host workstation. A copy of each image is then processed, preferably using automated image processing software. Processing includes such procedures as image file resizing (typically compressing or downsizing), cropping, installing a desired background, etc. The processed images are then uploaded as a product-specific file library onto a server for later retrieval and display to a user on her/his remote computer, tablet, smartphone, or other viewing device. Software is used to compose the individual images in a product-specific file library into an interactive 360 display that supports interactive features (e.g., “click and drag” mouse control (e.g., using a laptop or desktop computer) or “touch” or “swipe” control (e.g., on a smartphone's touchscreen) to view the product from any angle). This causes the product to appear on the user's viewing device as a fluidly rotating object.

In the context of the invention, the 360 product view photography also includes photographing the product as one or more its features is(are) moved. This can be accomplished, for example, by photographing a product having a moveable feature that can be open by first taking a plurality of digital photographs of the product as it is rotated through 360 degrees with the moveable feature in a “closed” position. The moveable feature is then partially opened, e.g., 20% opened, and the photography process is repeated, this time the plurality of digital photographs rotated through 360 degrees having the moveable feature in the 20% “open” position. This process can then be repeated as many more times as desired, with each successive rotation having the product further opened until in the last series of digital photos, the product's moveable feature is completely (i.e., 100%) open as it is rotated through 360 degrees. As with conventional 360 product viewing, the photo series taken during each rotation with the product being differentially positioned (e.g., to show a moveable feature move between its fully “closed” and “open” positions) is transferred to a digital file storage system so that the images can be processed and then stored as part of a product-specific file library on a server for later retrieval and display to a user on her/his viewing device.

The advantage of the invention is that, in addition to a user being able to rotate the product on her/his viewer, the user can also manipulate one or more moveable features of the product in order to better understand how the product actually appears and functions in the real world.

360 Product View Photography Studio

In practicing the invention, any suitable 360 product view photography studio can be employed. Such studios are typically devices that include a motorized turntable and control software that work in unison with a compatible digital camera. The control software synchronizes picture taking (i.e., image capture) and turntable movement to automate picture taking as an object rotates 360°. Preferably, the control software controls each aspect of the turntable, camera, picture-taking, and picture processing workflows. The system can capture as many pictures per complete rotation of the product on the turntable as desired and that is within the capability of the system's equipment.

In general, systems that allow a user to capture from 2 to about 30, 72, 120, 180, 240, 300, 360, 720 or more digital photos per rotation are employed. The rate of turntable rotation and frame capture rate may be among the variables that a user may set prior to beginning a particular photo session. The turntable can rotate clockwise or counterclockwise, including being adjustable to rotate in either direction. The size of the studio and turntable can vary, generally depending upon the physical dimensions and/or weight of the product being photographed.

In preferred embodiments, a large turntable, e.g., one equipped with 4′×1″ clear acrylic disk, is employed. Such a large clear acrylic disk allows objects to be photographed with no shadows as they may be illuminated from above and below and from the side, preferably using light boxes equipped with diffusers. Such consistent top/bottom/side lighting allows for easy clipping of backgrounds. The size and strength of a large clear acrylic disk additionally allows large, heavy objects (e.g., up to 500 lb.) to be photographed. Using a clear acrylic disk over glass also affords other advantages. For example, glass is almost always made with some amount of iron oxide, which causes it to appear slightly green. The thicker the glass, the more apparent this is, and when something is illuminated through glass it can take on a green tint, which then has to be edited out of subsequent images (to the extent this is possible). Use of a clear acrylic turntable platen eliminates such problems.

In order to minimize product “wobble” and other issues stemming from product placement on the turntable, it is desirable to center the product on the turntable before the image capture part of the process begins. Centering can be accomplished using any suitable approach. In some preferred embodiments, this is accomplished using at least two lasers positioned adjacent to turntable at 90° to each other such that their respective beans intersect directly over the center of the turntable. This allows for centering of the product to be imaged on the turntable as well as aligning the digital camera. Indeed, using such alignment lasers, millimeter level precision alignment is possible, which ensures the resulting images do not appear to wobble off axis.

In preferred embodiments, the studio is equipped with a suspension system to hold up products that cannot freely stand on the turntable. In some of these embodiments, the studio includes a monofilament winding and storage device in conjunction with an extruded aluminum support beam. A product can be attached to the monofilament via any suitable rigging method to suspend and balance the product while the disk rotates. Clear monofilament is preferably used to ensure that no shadows are cast, no tint is visible from light casting through the monofilament, and because it is very easy to edit out of the resulting images.

360 Product View Photography Process

In practicing the invention, any suitable 360 product view photography process can be employed. In some embodiments, the 360 product view photography process is fully automated such that once a product to be imaged is placed in the 360 product view photography studio, software controls operation the entire image capture, processing, and 360 product view composition in a single workflow once a technician initiates the process, for example, by releasing the shutter on a compatible digital camera (e.g., a Canon EOS 1Ds Mark IV, 5D Mark II, 5D Mark III, 6D, 7D, 7D Mark II, 40D, 50D, 60D, 60 Da, or 70D; Canon EOS Rebel XS, XSi, T1i, T2i, T3 & T3i, T4i, T5, T5i, or SL1; Canon PowerShot G9, G10, SX 100, SX 110, G5, G6, G7, A510, A520, A620, A640, A70, A75, A85, A95, S60, S70, S80, S1, S2, S3, or S5; and Nikon D3x, D4, D90, D300, D300S, D600, D700, D750, D800, D800e, D5000, D5100, D5200, D7000, D7100, or D810). In such embodiments, software automates image capture by synchronizing camera shutter release with product rotation, with the image capture rate set by the technician at the desired frames per one complete rotation (e.g., 30, 60, 90, 180, 360, etc. photos/complete rotation). Following (or during) the image capture phase, individual images (e.g., saved in JPG/RAW format) can be processed in a batch mode and then stored in a product image file library that can subsequently be used to provide 360 product views of the product. Data from the library preferably is optimized for web and mobile device display, such as HTML5, Flash, and/or GIF animations that support user-initiated movement of one or more moveable features of the particular product.

In some embodiments, the control software allows a user to view the product on a monitor or other display as the product rotates. This allows a user to make position, zoom, crop adjustments before the image capture process begins. It can also allow “wobble” issues (which are frequently the result of a product not being centered on the turntable) to be compensated for before image capture is initiated. The control software also allows the studio user or technician to select the number of pictures to take during one revolution, size of each image, the resolution for each image, and the direction of rotation of the turntable.

Once all of the parameters of a particular photo session are set in the control software (some or all of which parameters preferably have default settings in the control software), the control software synchronizes turntable movement (e.g., speed or rotation rate, starting, stopping, etc.) and the operation camera in order to automate image capture process, although the software may also provide for time-lapse and manual image capture options. While less preferred, the studio can also employ a digital camera not capable of automated operation. In such embodiments, the image capture process is not automated, although turntable movement may still be automated (e.g., synchronized with shutter release). In such embodiments, the control software preferably stitches the captured images together to, for example, create to create animated Flash (SWF) and/or GIF files.

After images of the product are captured (or during the image capture process), they first are typically stored on the camera's memory card. They are then are transferred to a computer for immediate or subsequent processing.

In some embodiments, the image processing software also provides the ability to replace the background in the images, for example, with a different color or texture, desired imagery, etc. In some embodiments, the image processing software also allows a technician to draw and/or write text (or other symbols) on some or all of the captured images, for example, to increase their communication value.

The process also preferably provides for digital “tiling” of large image files. In general, “tiling” involves segmentation of a large (e.g., high resolution) digital image into, for example, M digital image tiles defined by X rows by Y columns; thus, each tile can be uniquely defined by its X/Y coordinates. “Tiling” thereby facilitates scanning, storage, digital processing, and display (including zooming (i.e., changes of magnification) capability) of large digital images. Display of images generated in accordance with the invention can occur using any modern web browser, and thus can operate on or in conjunction with any e-commerce website on any device anywhere in the world as long as a connection to the internet is present. The display software is preferably written in the JavaScript programming language and thus can be embedded into any site that wishes to incorporate it by simply pasting in an appropriate code. An internal ID is passed into the system, and a convention-over-configuration approach is preferably taken to load images. As such, it is not necessary to know the name and location of every image file, as the image file names follow a naming convention based on tile position and location. This allows for extremely fast load times with little overhead. When a request is made to load the display of a product, the system initially loads all non-HD versions of images and then animates them all together to display either the product rotating or the product being operated or in use. When an end-user chooses to zoom in, HD tile images are loaded over the top of non-HD images to display extremely detailed versions of the product being viewed.

In preferred embodiments, the image processing software also provides tools exporting, editing, and importing for final stitching, as well as for exporting to another program such as Flash or QuickTime VR for final processing.

After image processing (including any retouching, final editing, etc.) is completed, the resulting image files are stored locally on a workstation computer, for example, the computer that controls the studio turntable, digital camera, and lighting equipment. A copy of the processed image files is also distributed to a server that provides remote, Internet access to clients (e.g., retailers, manufacturers, etc.). Content delivery network (CDN) distribution is preferably made available for each client and client website to serve content to end-users (e.g., clients, prospective buyers/consumers, etc.) with high availability and high performance.

An end-user can view images of a particular product available online by clicking on any linked HTML tag for the product that is available online. The process begins by loading images of the product to be displayed on top of the website where the initial linked, HTML-tagged image of the product was selected. The end-user can drag her/his mouse or finger on a touch device to rotate and/or operate the product. They can additionally click or double click to zoom in and out. “Pinch” zooming using a pinch gesture on a touchscreen may also be provided to allow zooming in and out, and a bar or other indicator (e.g., a zoom scale) may be included to allow the end-user to select the degree of zooming s/he desires.

When an end-user uses the invention to view images of a product online, it will appear as though s/he is actually spinning the product right in front of her/him, and when an end-user interacts with a stop motion, operable feature demonstration made possible by the invention, it will appear as though s/he is actually opening and closing (or otherwise operating) the operable or moveable feature of the product (e.g., an opening or expanding pocket, expanding and collapsing a foldable product frame, etc.), particularly when the end-user is viewing the product images on a touchscreen device.

### Examples

### 1. 360 Product View Photography Studio

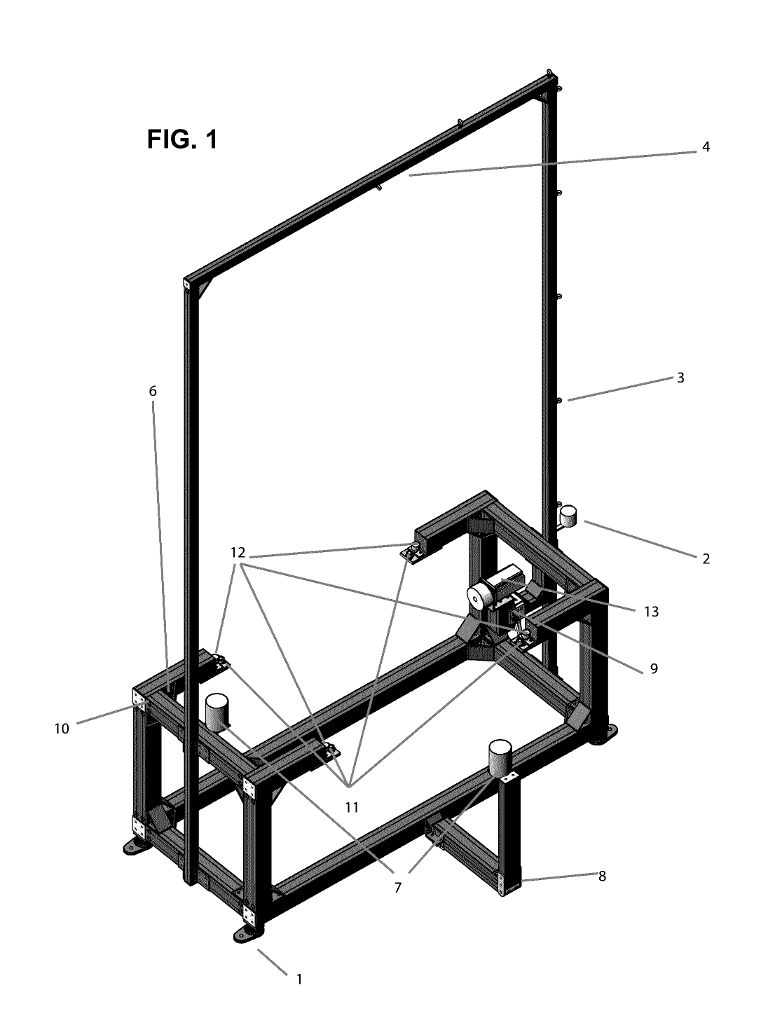

This example describes a particularly preferred 360 product view studio of the invention, as shown in FIGS. 1-4. The digital camera, lighting system, and computer system used in conjunction with the studio are not shown. In the figures, like numbers in different figures are understood to refer to the same elements.

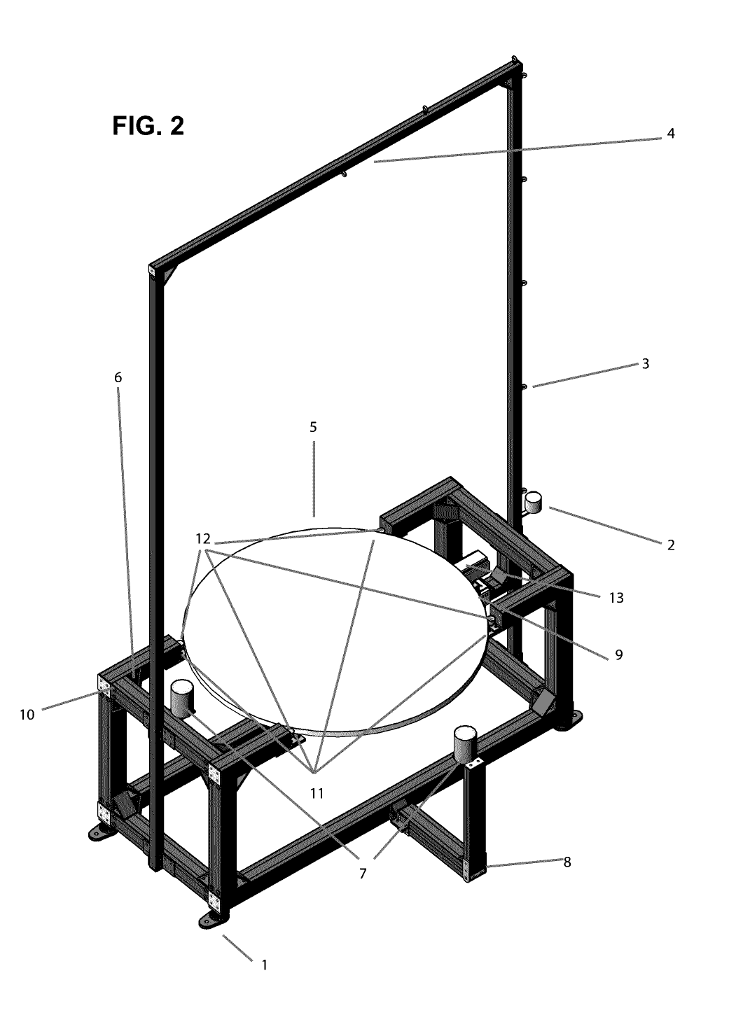

Turning to FIGS. 1 and 2, it shows the studio frame comprised of welded, extruded, rectangular aluminum beams having leveling feet (1) mounted to the underside of the extruded aluminum base and support beams (10) of the frame. A spool of monofilament line (2) is attached to one of the frame's vertical members. Several monofilament guides (3) are arrayed along the vertical member to which the spool (2) is attached and the upper, extruded aluminum cross-member (4) of the frame. Trusses (6) are used to brace various aluminum beams of the frame. Their location at every corner eliminates flexing of the frame during turntable disk (5; not shown in FIG. 1) rotation. Lasers (7) are positioned on the frame so that their beams (not shown) intersect above what is the center of the acrylic disk (5). One of the lasers is positioned atop a hinged arm (8) that can be rotated into position for aligning a product on the turntable disk and then be moved down out of camera's line of sight.

The turntable disk (5) is rotated by an electric stepper motor (13) that has a finned rubber roller that engages the outer periphery of the disk's underside. Gravitational force from the weight of the heavy disk ensures sufficient frictional contact between the roller and disk for smooth disk motion. The stepper motor (13) includes a handbrake adjustable motor tensioning arm (9). Stainless steel ball rollers (11) horizontally guide the disk (5) as it rotates. Vertically mounted polyurethane rollers (12) guide the disk laterally as it spins.

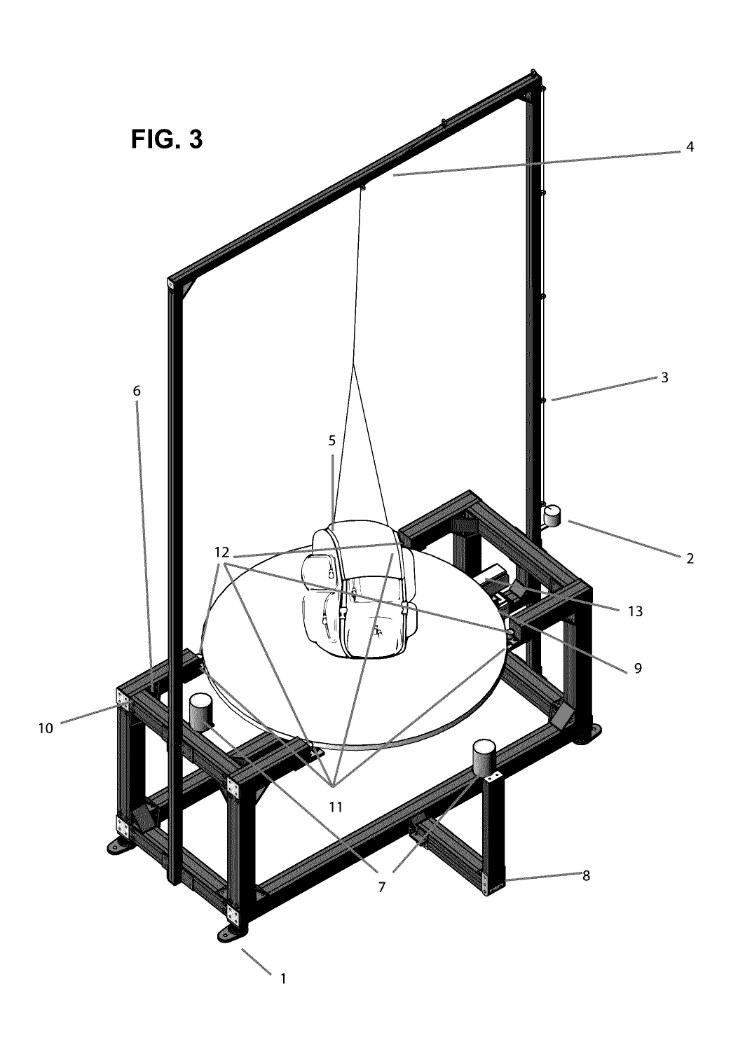

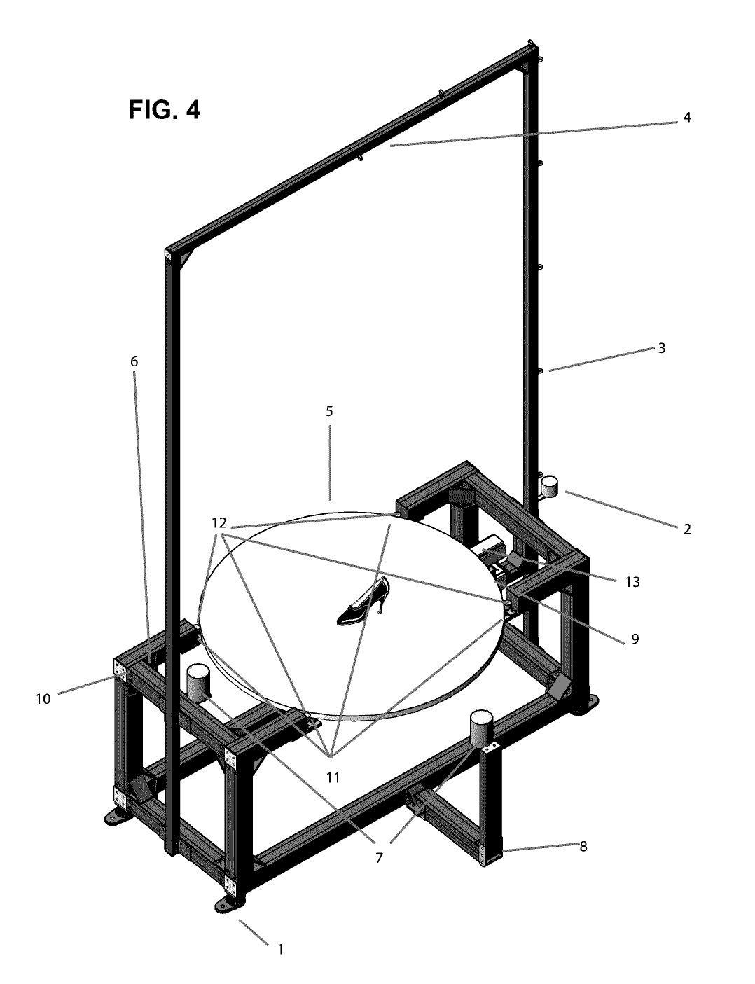

FIGS. 3 and 4 show a studio of the invention with a backpack suspended by monofilament line (FIG. 3) and a high-heeled shoe positioned on the acrylic disc (5).

### 2. 360 Product View System and Image Capture and Display Process

This example describes a representative 360 product view system of the invention for creating digital imagery that can be used in online marketing and merchandizing. This system employs a studio as described in Example 1.

In the system, once an object is placed on the studio's acrylic disk (5), a single button is clicked to start a process that rotates the disc, takes digital photographs with millisecond precision to ensure that a digital image is captured at the instant the product is has rotated the desired number of degrees, and then downloads the image files from the camera's memory card to the host workstation. Software on the host workstation then renders up to about a thousand images per complete revolution of the acrylic disk. Currently, 36 images are captured for each complete disk rotation, providing a digital image of the product after it has moved 10 degrees. Additionally, software on the host workstation can generates hundreds of tiles that are used to layer in an HD (high definition) version of the product when a user zooms in. After creating these image files, they are uploaded a central server, and an additional copy of one or more of the images can be retouched and/or further edited, if desired. After retouching and/or further editing, if any, the image files are then automatically uploaded to the central server, from which they can be called by a retailer and/or their prospective online customers.

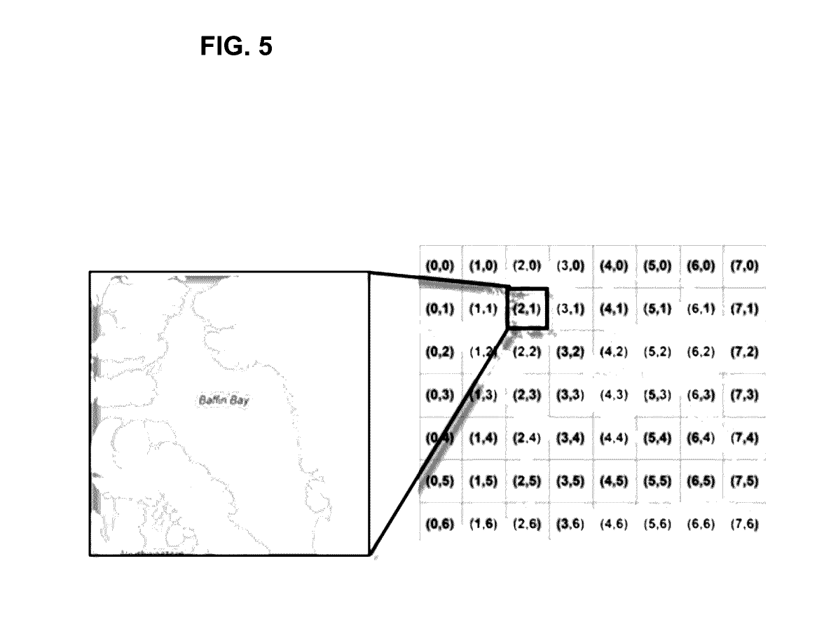

Data representing each image captured during the initial imaging process is first stored as a separate file on the camera's memory card. These files are then transferred onto a host workstation. The originally transferred files are retained in a secure location, and subsequent processing is performed on duplicate files created by the system. The host workstation then processes the duplicate image files, for example, cropping and resizing them down to an appropriate size for web-based display. Processing also often involves “tiling” HD image files, whereby a large (e.g., high resolution) digital image is segmented into, for example, 7 rows and 8 columns. Each “tile” can thus be defined by its row and column coordinates. An example of image tiling is shown in FIG. 5, where the “tile” at column 3, row 2 (here designated by the coordinates (2,1)) is selected. When so selected, a high resolution tile representing the selected position of an initially displayed, lower resolution image is presented. Depending on what part of the image a person zooms in on determines which tile(s)s will be loaded and presented on top of the initially displayed, lower resolution image. On smaller screens such as those found on smartphones, in general only a few tiles will be requested and loaded for viewing, while on a larger screen many more tiles may be loaded to represent an HD version of the product (or one of its components) being viewed.

### 3. Capturing Product Motion

One feature of the invention is its capacity to enable a person viewing images of the product online (e.g., a prospective online customer) to operate a moveable feature of the product. This capability is provided by photographing the product “stop motion” in the 360 product view studio. Photographing “stop motion” can be done in any suitable manner. In a preferred embodiment of “stop motion” digital photography used in the context of the invention, 3-6 photos per second of the product are taken while the product is operated or interacted with, allowing it to be captured “in live action”. If desired or necessary because of the particular product or moveable feature(s) to be made operable by, for example, a prospective online customer, a hand model may be employed (if a hand is not desired in the final image, is can be clipped out during subsequent processing or editing).

The following sections I-VI provide a guide to interpreting this specification.

### I. Terms

Product” means any machine, manufacture, and/or composition of matter, unless expressly specified otherwise. “Process” means a process, algorithm, method, or the like, unless expressly specified otherwise. Any process includes one or more steps, and therefore all references to a “step” or “steps” of a process have an inherent antecedent basis in the mere description of a process, or in the mere recitation of the term “process” or a like term.

The term “invention” means the one or more inventions disclosed in this application.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean one or more (but not all) embodiments of the invention. A reference to “another embodiment” in describing an embodiment does not imply that the referenced embodiment is mutually exclusive with another embodiment (e.g., an embodiment described before the referenced embodiment), unless expressly specified otherwise. Similarly, the mere fact that two (or more) embodiments are referenced does not imply that those embodiments are mutually exclusive. One embodiment of the invention may include or cover or embrace more than one other embodiment of the invention. For example, a first embodiment comprising elements a, b, and c may cover a second embodiment that comprises elements a, b, c, and d as well as a third embodiment covering elements a, b, c, and e. Similarly, each of the first, second, and third embodiments may cover a fourth embodiment comprising elements a, b, c, d, and e.

The term “represent” means (1) to serve to express, designate, stand for, or denote, as a word, symbol, or the like does; (2) to express or designate by some term, character, symbol, or the like; (3) to portray or depict or present the likeness of, as a picture does; or (4) to serve as a sign or symbol of “Represent” and like terms are not exclusive, unless expressly specified otherwise. For example, the term “represents” does not mean “represents only”.

The terms “including”, “comprising”, and variations thereof mean “including, but not necessarily limited to”. Thus, for example, the sentence “the machine includes a red widget and a blue widget” means the machine includes the red widget and the blue widget, but may possibly include one or more other items as well.

The term “consisting of” and variations thereof mean “including and also limited to”. Thus, for example, the sentence “the machine consists of a red widget and a blue widget” means the machine includes the red widget and the blue widget, but does not include anything else.

The terms “a”, “an”, and “the” refer to one or more. Thus, for example, the phrase “a widget” means one or more widgets, unless expressly specified otherwise. Similarly, after reciting the phrase “a widget”, a subsequent recitation of the phrase “the widget” means “the one or more widgets”. Accordingly, it should be understood that the word “the” may also refer to a specific term having antecedent basis. For example, if a paragraph mentions “a specific single feature” and then refers to “the feature,” then the phrase “the feature” should be understood to refer to the previously mentioned “a specific single feature.” (It is understood that the term “a” in “a specific single feature” refers to “one” specific single feature and not “one or more” specific single features.)

The term “plurality” means two or more

The phrase “at least one of”, when such phrase modifies a plurality of things (such as an enumerated list of things), means any combination of one or more of those things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”. In other words, the phrase “based on” covers both “based only on” and “based at least on”. The phrase “based at least on” is equivalent to the phrase “based at least in part on”.

“Herein” means in the present application, including anything that may be incorporated by reference.

“Whereby” is used herein only to precede a clause or other set of words that express only the intended result, objective, or consequence of something that is explicitly recited before the term “whereby”.

The term “condition” means (1) a premise upon which the fulfillment of an agreement depends, or (2) something essential to the appearance or occurrence of something else.

The term “transaction” means (1) an exchange or transfer of goods, services, or funds, or (2) a communicative action or activity involving two parties or things that reciprocally affect or influence each other.

“Encryption” refers to a process for obscuring or hiding information so that the information is not readily understandable without special knowledge. The process of encryption may transform raw information, called plaintext, into encrypted information. The encrypted information may be called ciphertext, and the algorithm for transforming the plaintext into ciphertext may be referred to as a cipher. A cipher may also be used for performing the reverse operation of converting the ciphertext back into plaintext. Examples of ciphers include substitution ciphers, transposition ciphers, and ciphers implemented using rotor machines.

In various encryption methods, ciphers may require a supplementary piece of information called a key. A key may consist, for example, of a string of bits. A key may be used in conjunction with a cipher to encrypt plaintext. A key may also be used in conjunction with a cipher to decrypt ciphertext. In a category of ciphers called symmetric key algorithms (e.g., private-key cryptography), the same key is used for both encryption and decryption. The sanctity of the encrypted information may thus depend on the key being kept secret. Examples of symmetric key algorithms are DES and AES. In a category of ciphers called asymmetric key algorithms (e.g., public-key cryptography), different keys are used for encryption and decryption. With an asymmetric key algorithm, any member of the public may use a first key (e.g., a public key) to encrypt plaintext into ciphertext. However, only the holder of a second key (e.g., the private key) will be able to decrypt the ciphertext back in to plaintext. An example of an asymmetric key algorithm is the RSA algorithm.

The terms “e.g.”, “such as”, and like terms mean “for example”, and thus do not limit the term or phrase they explain. For example, in the sentence “the computer sends data (e.g., instructions, a data structure, etc.) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

A numerical range includes integers and non-integers in the range, unless expressly specified otherwise. For example, the range “1 to 10” includes the integers from 1 to 10 (e.g., 1, 2, 3, 4, . . . 9, 10) and non-integers (e.g., 1.0031415926, 1.1, 1.2, . . . 1.9).

Where two or more terms or phrases are synonymous (e.g., because of an explicit statement that the terms or phrases are synonymous), instances of one such term or phrase does not mean instances of another such term or phrase must have a different meaning. For example, where a statement renders the meaning of “including” to be synonymous with “including but not limited to”, the mere usage of the phrase “including but not limited to” does not mean that the term “including” means something other than “including but not limited to”.

### II. Determining

“Determining” and grammatical variants thereof (e.g., to determine a price, determining a value, the determination of an object which meets a certain criterion) is used in an extremely broad sense, and encompasses a wide variety of actions and therefore “determining” can include calculating, computing, processing, deriving, investigating, looking up (e.g., looking up in a table, a database or another data structure), rendering into electronic format or digital representation, ascertaining, and the like. Also, “determining” can include receiving (e.g., receiving information), accessing (e.g., accessing data in a memory) and the like. Also, “determining” can include resolving, selecting, choosing, establishing, and the like.

“Determining” does not imply certainty or absolute precision, and therefore “determining” can include estimating, extrapolating, predicting, guessing, averaging, and the like. “Determining” also does not imply that mathematical processing must be performed, that numerical methods must be used, or that an algorithm or any particular device must be used.

performing one or more calculations. Calculating may include computing, processing, and/or deriving. A computing device may perform calculating. For example, calculating a thing may include applying an algorithm to data by a computer processor and generating the thing as an output of the processor.

“Determining” may also include “referencing”, which should be understood to include making one or more references, e.g., to a thing. Referencing may include querying, accessing, selecting, choosing, reading, and/or looking-up. A computing device may perform the act of referencing. For example, referencing a thing may include reading a memory location in which the thing is stored by a processor.

“Determining” may also include “receiving”. For example, receiving a thing may include taking in the thing. In some embodiments, receiving may include acts performed to take in a thing, such as operating a network interface through which the thing is taken in. In some embodiments, receiving may be performed without acts performed to take in the thing, such as in a direct memory write or a hard wired circuit. Receiving a thing may include receiving a thing from a remote source that may have calculated the thing.

### III. Examples and Terminology are not Limiting

The headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The disclosed invention is widely applicable to numerous embodiments, as is readily apparent from the disclosure. One of ordinary skill in the art will recognize that the disclosed invention may be practiced with various modifications and alterations, such as structural, logical, software, and electrical modifications. Although particular features of the disclosed invention may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not be interpreted as requiring features beyond those features that the claim expressly recites.

The present disclosure is not a literal description of all embodiments of the invention. Also, the present disclosure is not a listing of features of the invention that must be present in all embodiments.

All disclosed embodiments are not necessarily covered by the claims (even including all pending, amended, issued and canceled claims). In addition, a disclosed embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified. On the contrary, such devices need only transmit to each other as necessary or desirable, and may actually refrain from exchanging data most of the time. For example, a machine in communication with another machine via the Internet may not transmit data to the other machine for long period of time (e.g., weeks at a time). In addition, devices that are in communication with each other may communicate directly or indirectly through one or more intermediaries. Devices are in communication with one another if they are capable of at least one-way communication with one another. For example, a first device is in communication with a second device if the first device is capable of transmitting information to the second device. Similarly, the second device is in communication with the first device if the second device is capable of receiving information from the first device.

A description of an embodiment with several components or features does not imply that all or even any of such components or features is required. On the contrary, a variety of optional components are described to illustrate the wide variety of possible embodiments of the present invention. Unless otherwise specified explicitly, no component or feature is essential or required.

Although process steps, algorithms, or the like may be described in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Although a process may be described singly or without reference to other products or methods, in an embodiment the process may interact with other products or methods. For example, such interaction may include linking one business model to another business model. Such interaction may be provided to enhance the flexibility or desirability of the process.

An enumerated list of items (which may or may not be numbered) does not imply that any or all of the items are mutually exclusive, unless expressly specified. Likewise, an enumerated list of items (which may or may not be numbered) does not imply that any or all of the items are comprehensive of any category. For example, the enumerated list “a computer, a laptop, and a tablet computer” does not imply that any or all of the three items of that list are mutually exclusive and does not imply that any or all of the three items of that list are comprehensive of any category. Also, an enumerated list of items (which may or may not be numbered) does not imply that any or all of the items are equivalent to each other or readily substituted for each other.

All embodiments are illustrative, and do not imply that the invention or any embodiments were made or performed, as the case may be.

### IV. Computing

It will be readily apparent to one of ordinary skill in the art that the various processes described herein may be implemented by, e.g., appropriately programmed general purpose computers, special purpose computers, and other computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts, etc.

The term “compute” means to determine using a processor in accordance with an algorithm encoded, for example, in software.

A “processor” means one or more microprocessors, central processing units (CPUs), computing devices, microcontrollers, digital signal processors, graphics processing units (GPUs), or like devices or any combination thereof, regardless of the architecture (e.g., chip-level multiprocessing or multi-core, RISC, CISC, microprocessor without interlocked pipeline stages, pipelining configuration, simultaneous multithreading, microprocessor with integrated graphics processing unit, GPGPU, etc.).

Thus, a description of a process is likewise a description of an apparatus for performing the process. The apparatus that performs the process can include, e.g., a processor and those input devices and output devices that are appropriate to perform the process. For example, a description of a process is a description of an apparatus comprising a processor and memory that stores a program comprising instructions that, when executed by the processor, direct the processor to perform the method. The apparatus that performs the process can include a plurality of computing devices that work together to perform the process. Some of the computing devices may work together to perform each step of a process, may work on separate steps of a process, may provide underlying services that other computing devices that may facilitate the performance of the process. Such computing devices may act under instruction of a centralized authority. In another embodiment, such computing devices may act without instruction of a centralized authority. Some examples of apparatus that may operate in some or all of these ways may include grid computer systems, cloud computer systems, peer-to-peer computer systems, computer systems configured to provide software as a service, and so on. For example, the apparatus may comprise a computer system that executes the bulk of its processing load on a remote server but outputs display information to and receives user input information from a local user computer.

Further, programs that implement such methods (as well as other types of data) may be stored and transmitted using a variety of media (e.g., computer readable media) in a suitable manner. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

The term “tangible computer-readable medium” refers to a “computer-readable medium” that comprises a hardware component, such as optical or magnetic disks.

Thus, a description of a process is likewise a description of a computer-readable medium storing a program for performing the process. The computer-readable medium can store (in any appropriate format) those program elements that are appropriate to perform the method. For example, a description of a process is a description of a computer-readable storage medium that stores a program comprising instructions that, when executed by a processor, direct the processor to perform the method. Just as the description of various steps in a process does not indicate that all the described steps are required, embodiments of an apparatus include a computer or computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Various forms of computer readable media may be involved in carrying data (e.g., sequences of instructions, data representing a digital photograph, etc.) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), wireless local area network communication defined by the IEEE 802.11 specifications whether or not they are approved by the WiFi Alliance, SAP, ATP, Bluetooth, and TCP/IP, TDMA, CDMA, and 3G; and/or (iv) encrypted to ensure privacy or prevent fraud in any of a variety of ways well known in the art.

The term “database” refers to any electronically stored collection of data that is stored in a retrievable format.

The term “data structure” refers to a database in a hardware machine such as a computer.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The term “network” means a series of points or nodes interconnected by communication paths. For example, a network can include a plurality of computers or communication devices interconnected by one or more wired and/or wireless communication paths. Networks can interconnect with other networks and contain subnetworks.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium®, or Centrino, Atom, or Cor. processor, that are adapted to communicate with the computer. Any number and type of devices may be in communication with the computer.

In some embodiments, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

### V. No Disclaimer

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application will be prefaced by the phrase “does not include” or by the phrase “cannot perform”.

### VI. Alternative Technologies

It will be understood that the technologies described herein for making, using, or practicing various embodiments are but a subset of the possible technologies that may be used for the same or similar purposes. The particular technologies described herein are not to be construed as limiting. Rather, various embodiments contemplate alternate technologies for making, using, or practicing various embodiments.

Modifications, additions, or omissions may be made to the method without departing from the scope of the invention. The method may include more, fewer, or other steps. Additionally, steps may be performed in any suitable order without departing from the scope of the invention.

While this disclosure has been described in terms of certain embodiments and generally associated methods, alterations and permutations of the embodiments and methods will be apparent to those skilled in the art. Accordingly, the above description of exemplary or representative embodiments does not constrain this disclosure. Other changes, substitutions, and alterations are also possible without departing from the spirit and scope of this disclosure, as defined by the claims herein.

I claim:

1. A system for displaying a stop motion, image-based animation of a product of interest on a remote computing device display, optionally a display of a remote desktop or laptop computer, a tablet computer, or a smartphone in electronic communication with the system, the system comprising:
a. a remote, internet-connected storage device storing a digital image library that comprises a plurality of digital images of the product of interest taken from different angles, at least two of which show an operable feature of the product of interest in a different position; and
b. software or firmware that allows an Internet-connectable user device, optionally a desktop or laptop computer, a tablet computer, or a smartphone, in electronic communication with the system to (i) access, retrieve, and display on the device's display a plurality of images from the digital image library of the product of interest, and (ii) access, retrieve, and display on the device's display a stop motion, image-based animation of the product of interest in a manner that allows the user to interact with the animation via the touchscreen to observe functionality of the operable feature of the product of interest.

2. A method, comprising:
accessing via an e-commerce website a digital image library representing a product of interest having at least one operable feature, wherein the digital image library comprises a plurality of digital images of the product of interest taken from different angles, at least two of which show an operable feature of the product of interest in a different position; and
directing the display of a stop motion, image-based animation comprised of a plurality of images of the product of interest to a prospective buyer's remote computing device display, optionally a display of a remote desktop or laptop computer, a tablet computer, or a smartphone, in electronic communication with e-commerce website, wherein the display allows the prospective buyer to interact with the animation via the remote computing device display, optionally a touchscreen, to observe functionality of the operable feature of the product of interest.
